(19) United States
(12) Patent Application Publication
(10) Pub. No.: US 2025/0271068 A1
(43) Pub. Date: Aug. 28, 2025

(54) ROTARY SHEAR VALVE

(71) Applicant: Milwaukee Electric Tool Corporation, Brookfield, WI (US)

(72) Inventors: Jean Mauricio Uruena Montoya, Wauwatosa, WI (US); Timothy Radtke, New Berlin, WI (US)

(21) Appl. No.: 19/204,043

(22) Filed: May 9, 2025

Related U.S. Application Data
(63) Continuation-in-part of application No. 18/742,683, filed on Jun. 13, 2024.
(63) Continuation-in-part of application No. 18/182,978, filed on Mar. 13, 2023, now abandoned.
(60) Provisional application No. 63/508,250, filed on Jun. 14, 2023.
(60) Provisional application No. 63/319,134, filed on Mar. 11, 2022.

(51) Int. Cl. F16K 11/074; F15B 13/04

(52) U.S. Cl. CPC F16K 11/0743; F15B 13/0406; F15B 2211/30525

(57) ABSTRACT

A rotor for a directional control valve includes a rotor body defining a sealing surface, a circumferential side surface, and a stem that receives a rotational input to rotate the rotor about an axis. A first opening is formed in the sealing surface and defines a first perimeter. The first opening is positioned to move along a rotation path as the rotor body rotates and has a first notch that extends from the first perimeter toward a centerline of the rotor body that is perpendicular to the axis and along the rotation path. A second opening is formed in the sealing surface and defines a second perimeter. The second opening is positioned to move along the rotation path as the rotor body rotates and has a second notch that extends from the second perimeter toward the centerline of the rotor body and along the rotation path.

### CROSS-REFERENCE TO RELATED APPLICATIONS

The present application is a continuation-in-part of U.S. patent application Ser. No. 18/742,683, filed on Jun. 13, 2024, which claims the benefit of U.S. Provisional Patent Application No. 63/508,250, filed on Jun. 14, 2023, and is a continuation-in-part of U.S. patent application Ser. No. 18/182,978, filed on Mar. 13, 2023, which claims the benefit of U.S. Provisional Patent Application No. 63/319,134, filed on Mar. 11, 2022, each of which is hereby incorporated by reference in its entirety.

### BACKGROUND

Hydraulic tools and pumps can include one or more control valves, such as directional control valves, to connect and disconnect fluid pathways, including parts of a hydraulic circuit. Some control valves can include rotary shear seal valves having a rotor.

### SUMMARY

Examples of the invention provide systems and methods of a directional control valve. Directional control valves can include rotary valves, such as rotary shear seal valves. Some examples of rotary shear seal valves include a four-way, three-position valves.

According to one aspect of the present disclosure, a rotor for a directional control valve can include a rotor body defining a sealing surface, a circumferential side surface, and a stem. The stem may receive a rotational input to rotate the rotor about an axis. The rotor can also include a first opening formed in the sealing surface and defines a first perimeter. The first opening is positioned to move along a rotation path as the rotor body rotates. The first opening has a first notch that extends from the first perimeter toward a centerline of the rotor body that is perpendicular to the axis and along the rotation path. The rotor may further include a second opening formed in the sealing surface that defines a second perimeter. The second opening may be positioned to move along the rotation path as the rotor body rotates. The second opening has a second notch that extends from the second perimeter toward the centerline of the rotor body and along the rotation path.

In some examples, each of the first perimeter and the second perimeter has a circular shape and each of the first notch and the second notch may be formed as a triangular portion.

In some examples, the triangular portion may define an arcuate base and a peak opposite the arcuate base. The rotation path may bisect the arcuate base and intersects the peak.

In some examples, the rotor may further include a third opening formed in the sealing surface and defines a third perimeter. The third perimeter may define a circular shape that has an open area that is less than an open area of the first opening. The rotor may also include a fourth opening formed in the sealing surface that defines a fourth perimeter. The fourth perimeter may define a circular geometry and a surface area less than the first perimeter of the first opening.

In some examples, the first and the second openings may be in fluid communication with each other. The third and the fourth openings may be in fluid communication with each other.

In some examples, the first notch and the second notch may be shaped to facilitate a linear decrease in pressure when the rotor is rotated.

In some examples, the directional control valve may be rotated between three positions. A first position may fluidly couple the first opening with a pressure source and the second opening with a tank. A second position may fluidly couple the first opening with the tank and the second opening with the pressure source. A third position may be where the first opening and the second opening are not fluidly coupled to the tank or the pressure source.

In some examples, the first position may correspond to an extension of a piston rod within a cylinder of a piston cylinder assembly. The second position may correspond to a retraction of the piston rod within the cylinder of the piston cylinder assembly.

According to another aspect of the present disclosure, a shear seal control valve may include a valve body that defines first and second ports, and a rotor that is rotatably received in the valve body that has a plurality of openings formed in a mating surface of the rotor. The plurality of openings may be arranged to allow selective coupling of the first and the second ports as the rotor rotates in the valve body. The plurality of openings may include first and second openings that each define a perimeter that has a partially circular portion and a triangular potion. The respective triangular positions may define a notch of the respective first and second openings.

In some examples, the plurality of openings may include a third opening and a fourth opening that define a surface area less than the perimeter of the first opening and the second opening.

In some examples, the first and second openings may be in fluid communication with each other. The third and fourth openings may be in fluid communication with each other.

In some examples, the notches may provide a linear pressure decrease in hydraulic pressure as the rotor is rotated from a first position to a second position.

In some examples, the first opening may be coupled with a pressure source and the second opening may be coupled with the tank in the first position.

In some examples, the first opening may be coupled with the tank and the second opening may be coupled with the pressure source in the second position.

According to another aspect of the present disclosure, a method of operating a piston via a rotary shear seal valve may include rotating a rotor to a first position. A pressure source may be fluidly coupled with a first opening. A second opening may be fluidly coupled with a tank. A piston may be extended within a cylinder of a piston cylinder assembly that causes an operation on a workpiece. A rotor may be rotated to a second position. A first notch of the first opening may be fluidly coupled with the tank. A second notch of the second opening may be fluidly coupled with the pressure source. The piston may be retracted within the cylinder of the piston cylinder assembly.

In some examples, the rotor may rotate in a first rotational direction to reach the first position. The rotor may rotate in a second rotational direction to reach the second position. The first rotational direction may be opposite the first rotational direction.

In some examples, the method may further include rotating a rotor to a third position. The first opening, the second opening, the pressure source, and the tank may be fluidly decoupled.

In some examples, the third position may be a neutral position between the first position and the second position that blocks fluid flow through the first opening and the second opening.

In some examples, the first notch and the second notch may be located on a rotation path of the rotor that increases flow metering.

In some examples, the first notch and the second notch may be triangular-shaped.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is an isometric view of a hydraulic pump according to aspects of the disclosure.

FIG. 2 is an axonometric view of a hydraulic tool according to aspects of the disclosure.

FIG. 3 is a bottom isometric view of a rotor for a rotary valve according to aspects of the disclosure.

FIG. 4 is a side isometric view of a rotary shear valve including a rotor and valve discs.

FIG. 5 is a side isometric view of a rotary valve that includes valve discs and a first port and a second port.

FIG. 6 is a top isometric view of the rotary valve of FIG. 5.

FIG. 7 is a side isometric view of a rotary valve.

FIG. 8A is a bottom view of a rotor of a rotary valve in a first position.

FIG. 8B is a bottom view of the rotary valve of FIG. 8A in a middle position.

FIG. 8C is a bottom view of the rotary valve of FIG. 8A in a second position.

FIG. 9 is an isometric cross-section of a rotary valve in a first position.

FIG. 10 is a bottom view of a rotary valve in an intermediate position.

FIG. 11 is a zoomed in view of a notch on a rotor of a rotary valve.

FIG. 12 is a schematic view of a surface of the rotor of FIG. 3.

FIG. 13 is a zoomed in view of a port from the schematic of FIG. 10.

FIG. 14 is a schematic view of the surface of the rotor of FIG. 3 illustrating exemplary internal passageways of the rotor.

FIG. 15A is a schematic view of a valve in a first position.

FIG. 15B is a schematic view of the valve of FIG. 15A in a middle position.

FIG. 15C is a schematic view of the valve of FIG. 15A in a second position.

FIG. 16A is a schematic view of a valve in a first position and in communication with a piston.

FIG. 16B is a schematic view of the valve of FIG. 14A in a second position and in communication with the piston.

FIG. 17 is an isometric view of a directional control valve in a first configuration with a gear case removed to show internal components of the gearcase, according to some embodiments.

FIG. 18 is a top view of the directional control valve of FIG. 17.

FIG. 19 is a side view of the directional control valve of FIG. 17 with a gear case.

FIG. 20 is another side view of the directional control valve of FIG. 17 with a gear case.

FIG. 21 is an isometric view of the directional control valve of FIG. 17 with a gear case.

FIG. 22 is a cross-sectional view of the directional control valve of FIG. 21.

FIG. 23 is an isometric view of a directional control valve, according to some embodiments, in a second configuration.

FIG. 24 is an isometric view of the directional control valve of FIG. 23 without a gear case.

FIG. 25 is a cross-sectional view of the directional control valve of FIG. 23.

FIG. 26 is a flowchart of a method of positioning of a directional control valve with a stepper motor and a sensor.

FIG. 27 is a flowchart of a method of resetting the stepper motor position of FIG. 26.

FIG. 28 is a flowchart of a method of positioning of a directional control valve with a brushless motor and a sensor when a user pushes a first button.

FIG. 29 is a flowchart of a method of positioning of a directional control valve with a brushless motor and a sensor when a user pushes a third button.

FIG. 30 is a flowchart of a method of positioning of a directional control valve with a brushless motor and a sensor when a user pushes a second button.

FIG. 31 is a flowchart of a method of resetting a valve position in FIGS. 28-30.

FIG. 32 is a flowchart of a method of positioning of a directional control valve with a brushless motor and a sensor when a user pushes a first button.

FIG. 33 is a flowchart of a method of positioning of a directional control valve with a brushless motor and a sensor when a user pushes a second button.

FIG. 34 is a flowchart of a method of positioning of a directional control valve with a brushless motor and a sensor when a user pushes a third button.

### DETAILED DESCRIPTION

Pumps, including hydraulic tools having pumps, can include one or more valves to control fluid flow within a tool. Hydraulic tools can be used to perform a variety of operations including crimping, cutting, and pressing work. Some hydraulic tools can include valves, such as shear valves. For example, shear valves can be found in or near a sprocket assembly of a pump of a hydraulic tool. In some instances, the shear valve can be in communication with a cam shaft of the rotary drive system. In other instances, a rotor of a rotary shear seal valve can be in communication with a shaft operatively coupled to the rotor to turn the rotor and move the valve to different positions. The shaft may be rotated by a motor, manually, or combinations thereof.

A directional control valve (DCV) is a device that can control the direction of a fluid. The DCV can connect or disconnect parts of a hydraulic circuit. Some DCVs, including those described herein, can be configured as a 4-way and 3-position rotary shear seal valve. In general, rotary shear seal valves can include a rotor that has a defined layout for port communications. By rotating the rotor, communication between ports can change. Rotary shear seal valve also include shear seal discs that contact the rotor base to seal the ports. A 4-way and 3-position DCV has four ways (e.g., ports), including a first port, a second port, a third port, and a fourth port. For example, the first port can be a Pump Port (P) that connects to a pump, the second port can be a first work port (e.g., Port A (A)) that connects to a work function (e.g., a first end of a hydraulic actuator), the third port can be a third work port (e.g., Port B (B)) that connects to a work function (e.g., a second end of the hydraulic actuator), and the fourth port can be a Tank Port (T) that connects to a tank. The valve can be moved between three positions to selectively connect the four ports. In one particular example a first position (e.g., position “A”) can connect the pump port with the first work port and can connect the second work port to the tank port. A second position (e.g., position “B”) can connect the pump port with the second work port and can connect the first work port to the tank port. A third position (e.g., a neutral position or position “N”) can connect the pump port to the tank port, while blocking the first work port and the second work port. In that regard, the first and second positions can be work positions that cause a work operation to be performed, while the third position is a neutral position that allows hydraulic fluid to drain directly to a tank. Thus, when the rotor is shifted from neutral to A or B, fluid ports in the valve body will line up with fluid ports in the rotor to allow fluid to flow to the selected port.

In general, some hydraulic tools can be used to perform cuts or crimps on a work piece, such as a cable, a connector, or other objects. Generally, hydraulic tools include a cylinder and piston configuration, where the piston is configured to extend and retract within the cylinder, and thus, move jaws, or any other implement coupled to the piston to perform a task (crimping, cutting, lifting, retracting etc.). In some hydraulic tools, a hydraulic circuit can include a two- (or more-) position valve. In a three-position valve, fluid can be directed to extend a piston, which corresponds to a first valve position. In a second position, fluid can be directed to retract a piston. And in a third, or middle position, fluid can be prevented from entering or leaving a piston.

Some embodiments of the invention provide a rotor for a rotary shear seal valve. The rotor can be generally configured as a disk defining a rotor surface (e.g., a planar rotor surface). The rotor can include a plurality of outlet (or inlet) openings formed in the planar rotor surface. Furthermore, the rotor can include one or more auxiliary control paths, diversions, or notches in communication with a respective one of the plurality of outlet ports.

In use, the flow path diversions or notches formed at the perimeter of the of the outlet ports can improve flow metering while lowering a load during lifting applications. In general, a lifting application can include extending a piston (e.g., a hydraulic piston) to move a load against a force (e.g., gravity). The notches can define a triangular (or other) geometry that can help a user to control a flow back for a more significant range of motion during rotor rotation. The notches can advantageously facilitate backflow control and help manage flow metering. Embodiments of the invention provide a rotor having notches or flow path diversions at first and second port outlets (or others) on a rotor of a rotary shear seal valve.

In general, during valve rotation, the notches in the rotor cross a perimeter of the port (i.e., a perimeter of the port formed in a planar surface), which creates an open area (e.g., a flow path diversion) that allows flow from a pressurized port to a reservoir (e.g., a tank). As the angle of rotation increases, the flow can increase because the open area formed at the notch/port perimeter increases. Therefore, depending on the notches' angular location with respect to the port's planar surface perimeter, a user can precisely control the opening area for flow by controlling the angle of the rotor. Without the notches, the angle of controlling the open area is minimal and difficult to precisely manipulate or adjust. That is, by providing notches, the rate of change in open area per degree of rotation is increased at the notches as compared with a main portion of the opening. As a result, a larger magnitude rotation is necessary to increase the open area when only the notches are exposed to form part of the flow path, which allows the open area to be controlled more precisely by a controller during flow metering and also enhances flow stability.

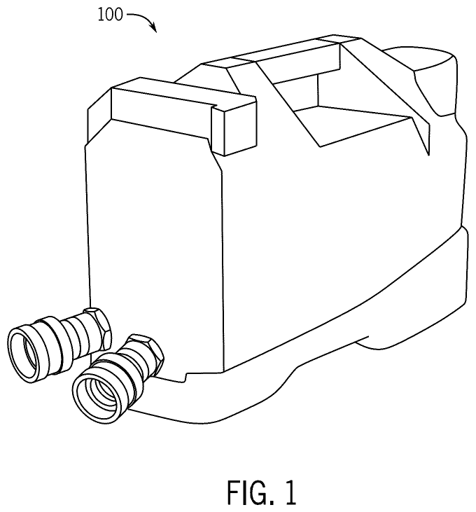

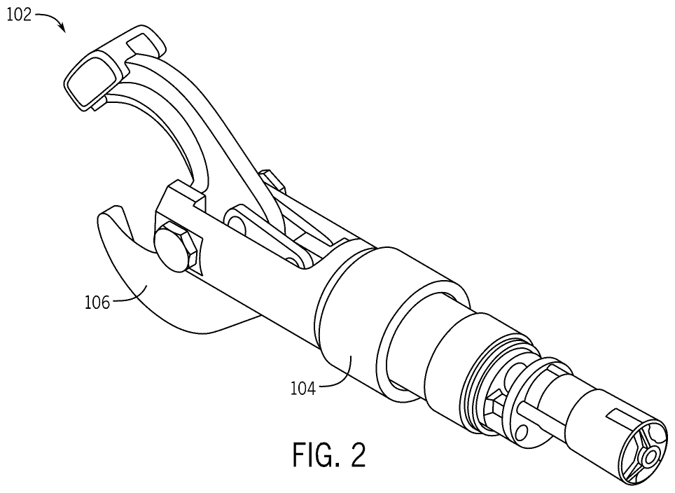

FIG. 1 illustrates an example hydraulic pump 100 and FIG. 2 illustrates an example hydraulic tool 102, in accordance with the present disclosure. Although the example implementation describe herein depicts a cutting tool (e.g., cutter), the features of this disclosure can be implemented in other similar tools, such as knockout tools or crimping tools (e.g., crimper). In addition, any suitable size, shape, or type of elements or materials could be used. The illustrated hydraulic tool 102 includes a housing 104, and a working head 106 (e.g., cutting head) that is coupled to the housing 104 to perform an operation on a work piece. The working head 106 is illustrated as a cutting head; however other types of working heads can also be used or include additional or alternative crimping or cutting features near the cutting head. In some examples, the hydraulic tool 102 can be battery operated.

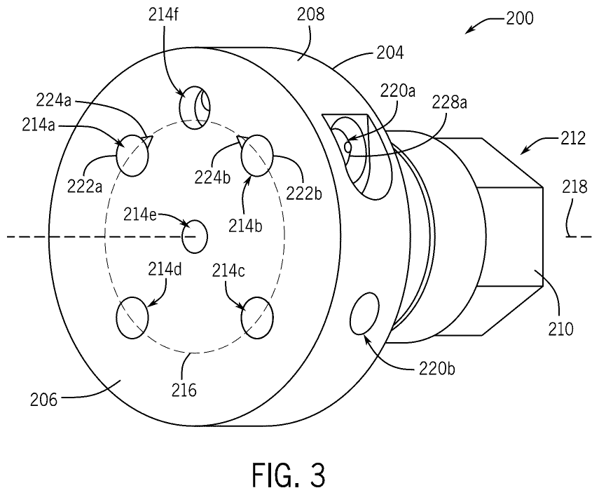

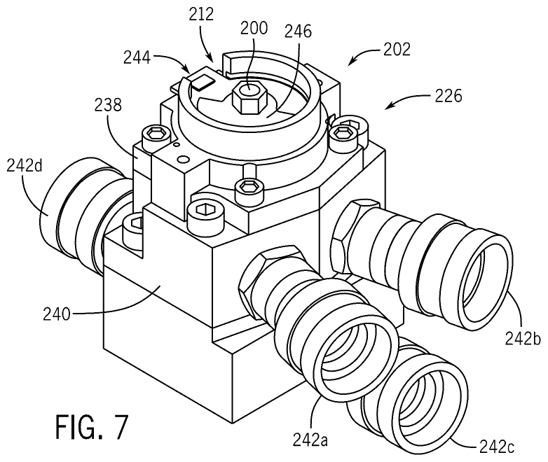

FIGS. 3-16 illustrate aspects of an example valve 202 that allows for improved flow control, as may provide for flow metering, particularly at low flow rates. The valve 202 is configured as a rotary shear valve 202 (e.g., rotary valve) can be used to control a work operation in a power tool, in particular the hydraulic power tool 102 (e.g., a crimper or cutter), as well as other applications for controlling fluid flow (e.g., hydraulic pump 100). As shown in FIG. 7, the rotary shear valve 202 generally includes a valve body 226 having a base 240 and a valve cap 238 that are coupled together and that defines a plurality of ports. As illustrated, the valve 202 is configured as four-way, three-position valve having a first port A, a second port B, a third port P, and a fourth port T. In this case, the first port A is a first work port that couples to a work function, the second port B is a second work port that couples to a work function, the third port P is a pump port that couples to a pump, and the fourth port T is a tank port configured to couple to a tank. In general, fluid flows from the third port P and may either flow into the first port A, the second port A, or flow to the fourth port T, depending on the position of the rotor 200, as will be further discussed below. In other applications, more or fewer ports can be provided, and the ports can couple to other external components to meet the needs of a particular application. To that end, each of the ports A, B, P, T can be provided with a connector 242 (e.g., a threaded connection, quick-connect fitting, or another type of connection interface) to facilitate a connection to the external components.

A valve is operable between a plurality of positions to selectively connect ports to provide flow control. To connect the ports, a valve includes a control member that is moveable to selectively connect the ports. In the illustrated example, the valve 202 includes a control member that is configured as a rotor 200 that is rotatably retained in the valve body 226. That is, the rotor 200 can rotate within the valve body 226 to selectively connect the ports A, B, P, T, and described in greater detail below. As shown in FIG. 3, the rotor 200 includes a rotor body 204 that defines a mating surface 206 (e.g., a sealing surface), a circumferential side surface 208 (e.g., a side surface or peripheral surface), and a stem 210. In general, the stem 210 can provide a rotational control of the rotor 200 and includes an input receiving portion 212. The input receiving portion 212 can receive a manual or motorized input to turn the rotor body 204. The rotor 200 can further define a plurality of openings 214 (e.g., cavities) to selectively connect the ports A, B, P, T within the valve body 226. For example, a first opening 214a, a second opening 214b, a third opening 214c, and a fourth opening 214d can be formed in the mating surface 206 and disposed along a rotation path 216 of the rotor 200, so that as the rotor 200 rotates, the openings 214 can be positioned to provide a connection between the ports A, B, P, T, as described in greater detail below. Furthermore, (auxiliary) openings 214e, 214f can also be disposed within the mating surface 206. In the illustrated embodiment, the opening 214e can be formed at a central location relative to the mating surface 206 and the rotation path 216, and the opening 214f can be configured as a through-hole extending through the disk portion of the rotor in an axial direction (e.g., along an axis of rotation of the rotor).

In some cases, the openings 214 form internal passageways within the rotor body 204. In some cases, the openings 214 on the mating surface can connect with openings on another surface to allow the openings 214 to connect with one or more of the ports A, B, P, T. For example, with continued reference to FIG. 3, the rotor body 204 can further include openings 220a, 220b that are provided on the circumferential surface 208 of the rotor body 204. In the illustrated example, the opening 220a can be in fluid communication with each of the openings 214a and 214b, and the opening 220b can be in fluid communication with each of the openings 214c and 214d. However, other configurations are possible. Furthermore, one or more of the openings 220 can include a plug 228a. For example, the opening 220a can be plugged so that a fluid pathway only exists distinctly between the first and second ports 214a, 214b formed in the mating surface 206.

Each of the openings 214a-f can define a respective opening perimeter 222 that defines the opening to the respective port 142. For example, the first and second openings 214a, 214b define respective first and second perimeters 222a, 222b. As will be described further with reference to FIGS. 6 and 7 below, the first and second perimeters 222a, 222b can define respective notches 224a, 224b. The notches 224a, 224b generally form a triangular indentation into the mating surface 206 that is in fluid communication with each of the first and second openings 214a, 214b. That is, for example, if an external planar surface was planarly aligned and butted up against (e.g., flush with) the mating surface 206 of the rotor 200 in an axial direction 218, a discrete pathway would be formed between the first notch 224a, the first opening 214a, the second opening 214b, and the second notch 214b. In other examples, differently shaped or sized notches can be provided to achieve a desired flow characteristic.

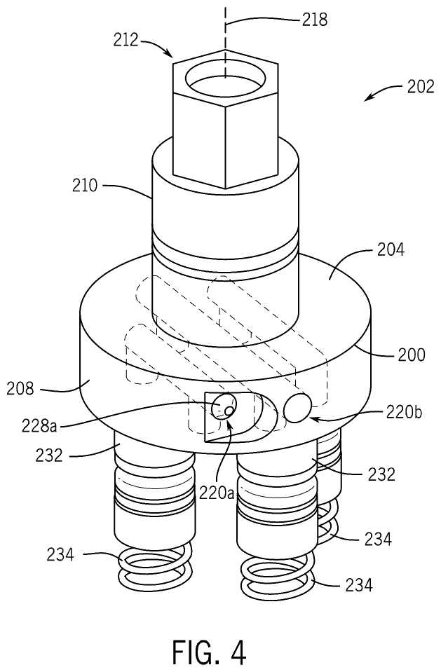

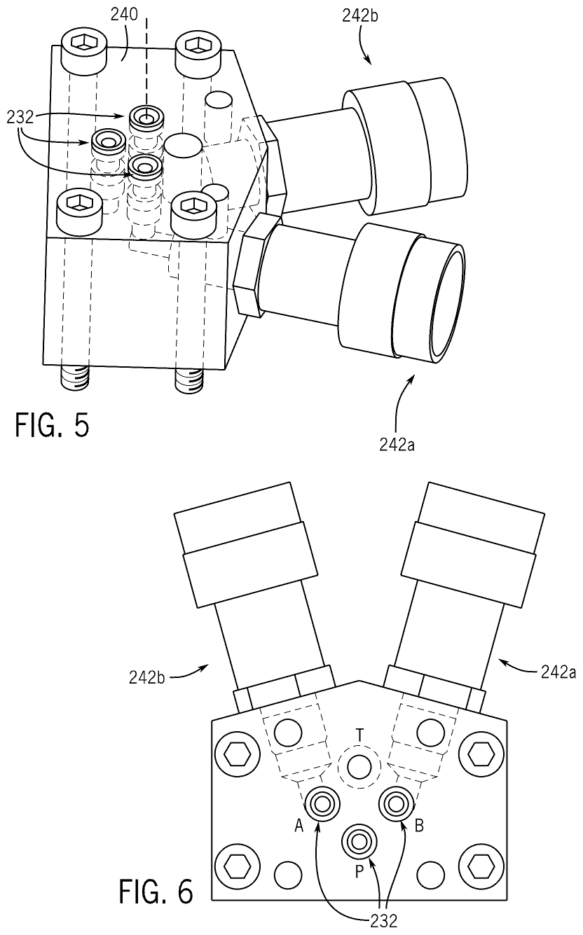

With reference now to FIG. 4, an exemplary assembly of the rotor 200 with the openings 220a, 220b on the circumferential side surface 208 is shown. As described above, the openings 220a, 220b may be in fluid communication with the plurality of openings 214 on the mating surface 206 of the rotor 200. The assembly of FIG. 4 further includes a set of discs 232 (e.g., shear seal discs) and a set of springs 234 that are positioned proximate the mating surface. In the illustration, three discs 232 and three springs 234 are shown in the set of discs 232 and the set of springs 234, respectively, however; other configurations are possible. The set of discs 232 can provide high valve cycle lift, tight sealing, and positive load control. Furthermore, the valve 202 can include first and second connectors 242a, 242b that extend laterally outward from a base 240 of the rotary shear valve 202 (FIGS. 5 and 6) and fluidly couple with the plurality of openings 214 of the rotor 200. As shown in FIG. 5, the discs 232 are housed in the base 240 and are biased to contact with the mating surface 206 of the rotor 200 by the springs 234 (e.g., or another type or resilient member, such as a bushing) to provide sealing between the plurality of openings 214 and Port A (e.g., a first port or work port), Port B (e.g., a second port or work port), and pressure port P. More specifically, as shown in FIG. 6, the discs 232 (e.g., three shear seal discs) align with Port A, Port B, as well as Port P (e.g., pump port or pressure port). In some cases, Port T (e.g., a tank port or drain port) may also include a disc and spring. This alignment allows fluid to flow through each port, while preventing fluid from leaking between each port and the mating surface 206 of the rotor 200.

With reference to FIG. 7, an assembled configuration of the rotary shear valve 202 illustrates the rotary shear valve 202 that further includes the rotor 200, the valve body 226, the valve cap 238, the base 240, and a sensor 244. The sensor 244 can be used to control the rotor 200 position. The sensor 244 may include a sensor arm 246 that is coupled to the rotor 200 and in fluid communication with the plurality of openings 214. The sensor 244 may be a ZMID (Zinc Metal Ion Detector) sensor or a Hall sensor, however other sensors are possible (e.g., contact switch, position sensors, etc.).

In use, when the valve 202 (i.e., the rotor 200) rotates between a plurality of positions, the valve 202 connects the plurality of openings 214 of the rotor 200 to Port A, Port B, Port T, and Port P of the base 240 or the valve body 226 to direct flow between various combinations of the fourth connector 242d (e.g., Port T), the third connector 242c (e.g., Port P), and the first and second connectors 242a, 242b (e.g., Ports A and B).

In some embodiments, the valve 202 is configured to be a part of a hydraulic system which also includes a load cylinder and a high-force load ram. The load ram can separate the load cylinder into a rod end and a cylinder end. An inner cylinder can extend through the cylinder end and can be used for rapid advancement of the load ram. Continuing with FIG. 7, Port A (e.g., connector 242b) can be configured to be in fluid communication with the inner cylinder and can be configured to be selectively in fluid communication with the cylinder end of the load cylinder. Port B (e.g., connector 242a) can be configured to be in fluid communication with the rod end of the load cylinder. Port P (e.g., connector 242c) can be configured to be in fluid communication with a high pressure pump and fluid reservoir. Port T (e.g., connector 242d) can be configured to be in fluid communication with a tank (e.g., reservoir).

In some embodiments, the valve 202 is configured to be a part of a hydraulic system that can be used for rapid advance ram extension, high force ram extension (e.g., a higher force than a rapid ram extension), ram retraction, system overload protection at high pressure, low pressure protection at the rod end of the load cylinder, and system decompression. In particular, during rapid advance ram extension, Port P (e.g., the valve connector 242c) of the rotary valve 202 of FIG. 7 can be in fluid communication with Port A (e.g., the valve connector 242b). During such rapid advance ram extension, Port A is in communication with the inner cylinder of the load cylinder to move the load ram within the load cylinder, and Port A is blocked from fluid communication to the cylinder end of load cylinder. Additionally, during each of a rapid advance ram extension and a high force ram extension, Port A is in fluid communication with Port P.

In some embodiments, during a ram retraction phase, Port A can be in fluid communication with Port T (e.g., the valve connector 242d) to drain hydraulic fluid from the cylinder end of the load cylinder and the inner cylinder so that the load ram can retract. Additionally, during ram retraction, Port B (e.g., the valve connector 242a) is in fluid communication with Port P so that high pressure fluid can be directed to the rod end of the load cylinder to retract the load ram. In some cases, Port P can be in fluid communication with Port B provides hydraulic cylinder retraction and eliminates the need for a return spring.

In some embodiments, during a system overload protection from high pressure, a high-pressure relief valve that is pre-set above a system pressure can allow high pressure fluid to flow from the cylinder end to the rod end and out to a tank. Accordingly, during a system overload protection from high pressure, Port B (which can be configured to connect to the rod end of the load cylinder) is in fluid communication with Port T. The system overload protection may occur during a rapid advance ram extension or a high force ram extension.

In some embodiments, during a low pressure protection at the rod end of the load cylinder, a low pressure relief valve that is preset at a low pressure (e.g., 1000 psi) can allow fluid to flow from the rod end to the cylinder end and out to a tank. Accordingly, during a low pressure protection at the rod end of the load cylinder, Port A (which can be configured to connect to the cylinder end of the load cylinder) is in fluid communication with the Port T. The low pressure protection may occur during ram retraction.

In some embodiments, system decompression can occur when Port A is in communication with Port P and a manual release valve relieves pressure from a high pressure piston pump and a reservoir. Further, Port B is in communication with Port T during system decompression.

In general, embodiments of the rotary valve 202 described herein can be configured to a hydraulic system to allow for double acting cylinder operation (i.e., extension and retraction) while providing pressure protection in both directions.

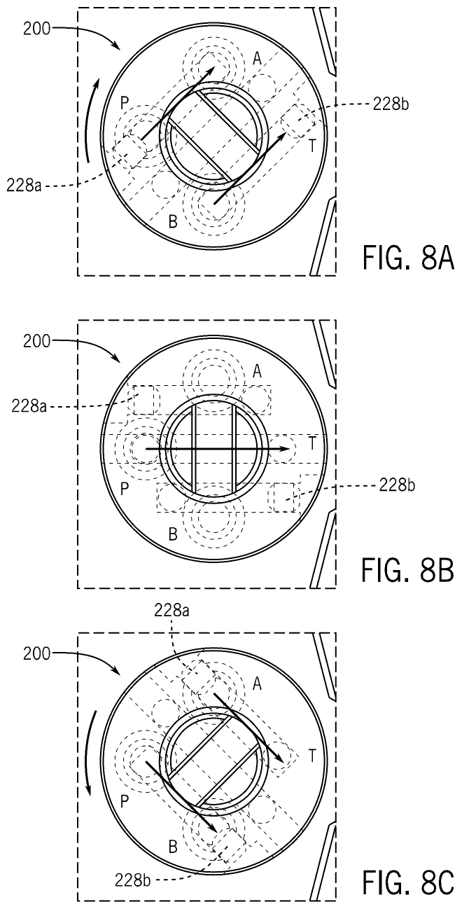

FIGS. 8A-C illustrate exemplary orientations of a rotor, such as the rotor 200, rotating between different positions. For example, in FIG. 8A, a first position (e.g., position 1 (Port A)) is shown. In the first position, Port P (connector 242c) is in fluid communication with Port A (connector 242b) and Port T (connector 242d) is in fluid communication with Port B (connector 242a). When the valve 202 rotates, the openings 114 direct flow accordingly. As the rotor 200 rotates in the direction indicated in FIG. 8A to the third position (e.g., middle position or neutral) shown in FIG. 8B, the valve is moved to third position where neither the Port T nor Port P are in communication with either Port A or Port B. As the rotor 200 rotates again, Port P can be in fluid communication with Port B and Port T can be in fluid communication with Port B. Optionally, as shown in FIGS. 8A-C, plugs 228a, 228b may be provided that block fluid flow (e.g., close passages connecting ports) through the openings 220a, 220b provided on the circumferential surface 208 in each position to further regulate fluid flow, control fluid pressure, as well as prevent fluid leakage. In particular, the plugs 228a, 228b may further provide a means for releasing fluid pressure gradually, as the plug 228a covers opening 220a as fluid flows to Port T and the plug 228b covers opening 220b as fluid flows from Port P into Port B, as shown in FIG. 8C in a second position (e.g., position 2 (Port B)). Conversely, the plugs 228a, 228b may allow for a steady pressure build as the plug 228a partially covers opening 220a as fluid flows into Port A, and the plug 228b covers the opening 220b as fluid flows into Port T from Port B. In some embodiments, the openings 220a, 220B may be closed by welding. Overall, when the valve 202 rotates, the valve 202 connects the openings 214 to direct the flow from Port P to Port A or Port B, and Port A or Port B to the Port T. In the middle position, flow from Port P goes to Port T while Port A and port B are closed. When the rotor 200 is shifted from neutral to Port A or Port B, fluid ports in the valve body lines up with the fluid ports in the rotor to allow fluid to flow to the proper port. More specifically, in the first position, Port P is in communication with Port A while Port B is in communication with Port T. In the middle position, Port P is in communication with Port T while Port A and Port B are blocked (e.g., no flow). In the second position, Port P is in communication to Port B while Port A is in communication with Port T.

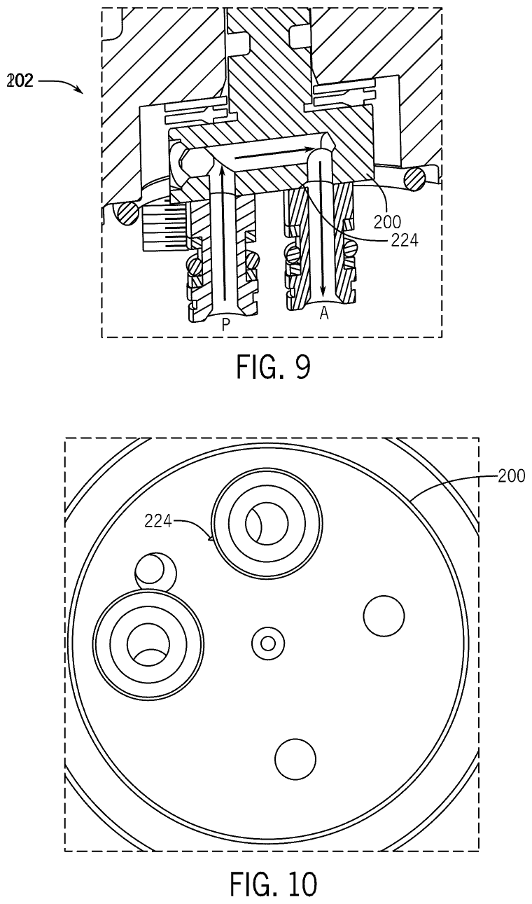

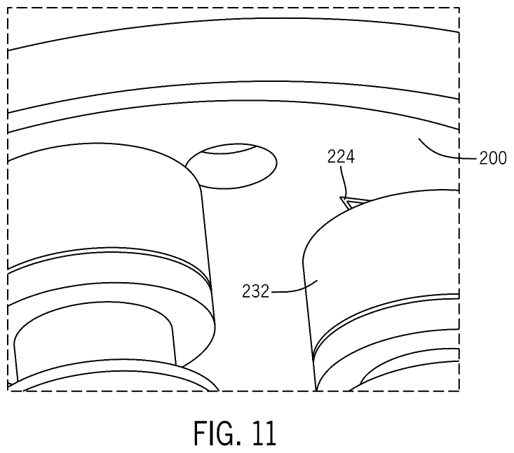

FIG. 9 illustrates a cross-sectional view of the position of the rotor 200 shown in FIG. 8A with Port P in fluid communication with Port A. As a result, fluid can flow from the pressure source to Port A, as indicated by the arrow in FIG. 9. With reference to FIGS. 10 and 11, when the rotor 200 starts to rotate toward the middle (e.g., neutral) position, the fluid diversion pathways or notches 224 allow a bypassing flow to the cavity inside the valve cap 238, which is connected to a tank. For example, the notch 224 allows fluid to flow past the seal surface created by the disc 232.

The notches 224 are located on the rotation path 216, which advantageously allows the rotation angle range where the notches 224 provide flow metering to be greater. Thus, the user can move the rotor 200 a certain angle and slowly let the flow be controlled and metered. Having notches 224 that provide controlled flow allows flow metering at higher pressures and reduces or prevents a sudden loss of load or pressure drop. In general, notches allow fluid or pressure to slowly be released to the tank and can provide finer tuned flow metering compared to a rotor without notches only being slowly turned. For example, notches can provide a linear pressure decrease in the system as the rotor is turned.

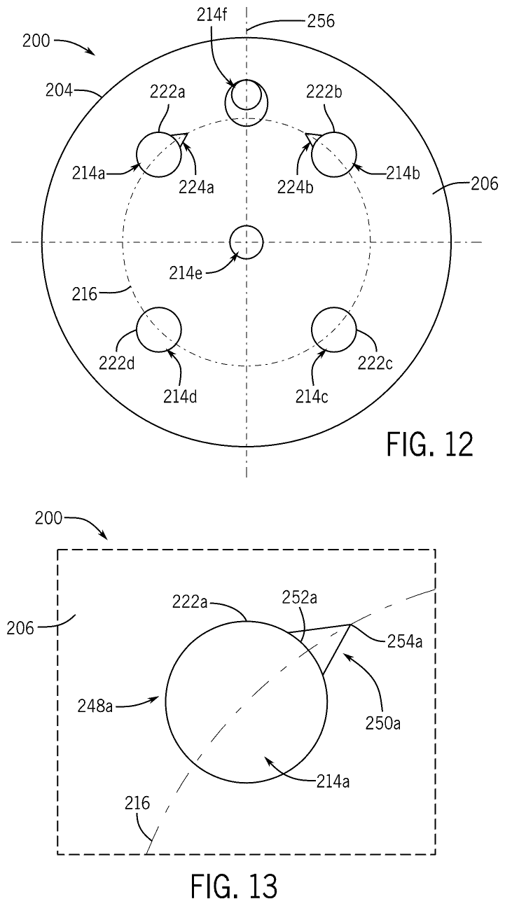

FIG. 12 illustrates a bottom schematic view of the rotor 200 and the plurality of openings 214a-f. Each of the first, second, third, and fourth openings 214a-d are disposed along the rotation path 216. The rotation path 216 defines that circumference around which the first, second, third, and fourth openings 214a-d are positioned and travel when the rotor 200 rotates and generally corresponds to a complementary positioning of the discs 232 that engage the mating surface 206 at the respective openings 214. In the illustrated embodiment, there are four openings 214a-d disposed around the rotation path 216. However, in other embodiments, additional or fewer ports may be formed in the mating surface 206 about the rotation path 216 or otherwise.

As briefly described, each of the openings 214 can define a respective perimeter 222. The perimeters 222c, 222d of the openings 214c, 214d define a generally circular geometry. In contrast, the perimeters 222a, 222d define a partially circular geometry with a cutout that defines the respective notch 224a, 224b. In this case, the notches 224 have a triangular geometry; however other geometries are possible. The notches 224a, 224b increase the open area of the respective opening 222a, 222b of the openings 214a, 214b (e.g., as compared to the perimeters 222c, 222d of the openings 214c, 214d). In general, the notches can improve the valve's lifting application performance. In particular, the notches 224a, 224b can facilitate controlled lowering of active loads by allowing for finer control of flow rates.

FIG. 13 illustrates a zoomed in version of the notch 224a. As shown, the perimeter 222a of the of the opening 214a includes a generally circular portion 248a and a generally triangular portion 250a that defines the notch 224a. The triangular portion 250a includes a base 252a that defines the same radius of curvature as the circular portion 248a of the perimeter 222a. In some cases, the notch 224 is positioned so that the base 252a is bisected by the rotation path 216. Furthermore, the triangular portion 250a includes a peak 254a. The peak 254a is disposed along the rotation path 216. In some embodiments, the triangular portion 250a may generally define a scalene triangle such that each of the three sides are different lengths. However, other geometries are possible. Furthermore, it should be appreciated that, though not shown in detail, the notch 224b can define similar (though mirrored across a vertical line 256, shown in FIG. 8) features and geometries as the notch 224a. Notably, each peak of the notches 224a, 224b extends along the respective perimeter 222a, 222b and rotation path 216 toward a centerline 256 of the rotor 200. That is, the portion of each perimeter 222a, 222b that is closest to the centerline 256 is the respective peaks (i.e., peak 254a for the opening 214a). This arrangement allow the notches to become exposed in accordance with the direction of rotation of the rotor 200, as may allow for flow metering.

In other embodiments, the perimeters (e.g., the perimeters 222a, 222b) can define other geometries that provide a controllable or metered flow as the rotor 200 moves from a high pressure fluid communication position. For example, the perimeter or port shapes can define an oval or kidney bean shape. Additionally or alternatively, a notch can also include a triangular geometry with curved sides to provide a linear or otherwise controlled flow to a tank or reservoir as the rotor rotates. In general, perimeter geometries described herein can provide an increased range of rotation of the rotor to meter flow of high pressure fluid to a tank, such as during a load lowering event.

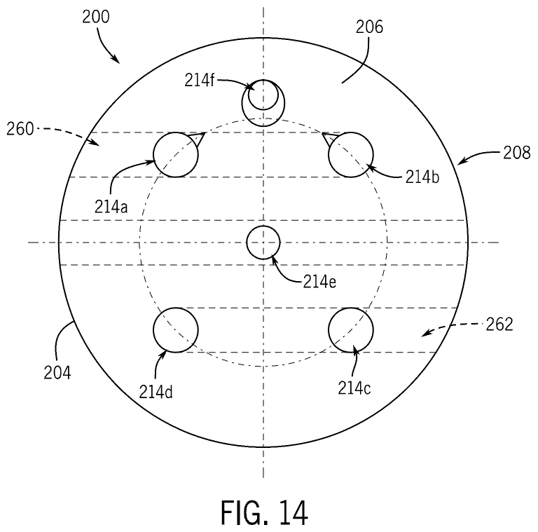

FIG. 14 illustrates another bottom schematic view of the rotor 200. As shown, the first and second openings 214a, 214b can be in fluid communication via a first internal passageway 260 extending through the rotor body 204. Similarly, the third and fourth openings 214c, 214d can be in fluid communication via a second internal passageway 262. The internal passageways 260, 262 can be configured as holes (e.g., blind holes) that were formed by drilling (or milling, etc.) through the circumferential side surface 208 of the rotor 200. Depending on the rotor configuration (e.g., number of positions and pathways) additional or fewer ports and passageways can be formed in the body 204 of the rotor 200. Furthermore, one or more of the internal passageways 260, 262 may be plugged at the circumferential side surface 208 or open to provide a port on the circumferential side surface 208 (e.g., the openings 220a, 220b of FIG. 3).

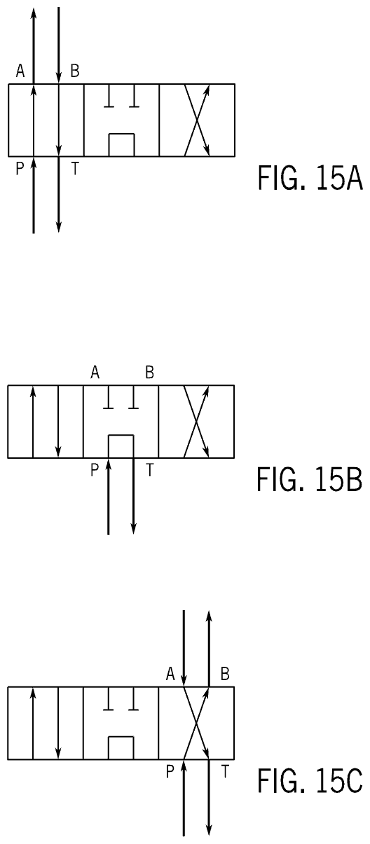

FIGS. 15A-C illustrate a rotary shear valve, such as the valve 202, in three different positions. These positions generally correspond to those illustrated in FIGS. 8A-C. For example, in FIG. 15A, Port A can be in fluid communication with the Port P and Port B can be in fluid communication with Port T. FIG. 15B illustrates the valve in the third position (e.g. a middle, or neutral position), in which neither of Port A and Port B are connected to the Port T or Port P. FIG. 15C illustrates the valve 202 in the second position in which Port A is in fluid communication with the Port T and Port B is in fluid communication with Port P.

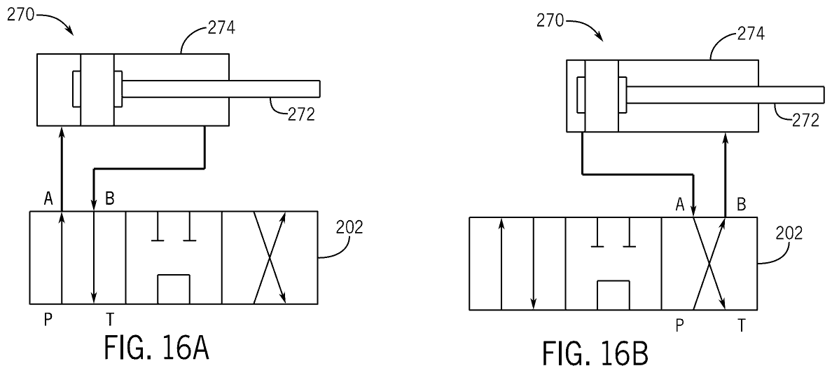

FIGS. 16A and 16B illustrate schematic representations of the rotary shear valve 202 and the fluid communication to an exemplary piston cylinder assembly 270. FIG. 16A illustrates the valve 202 in the first position that corresponds to an extension of the piston rod 272 within the cylinder 274 of the piston cylinder assembly 270. FIG. 16B illustrates the valve 202 in the second position that corresponds to a retraction of the piston rod 272 within the cylinder 274. In some embodiments, when the valve 202 is in the second position as illustrated in FIG. 16B, the first opening 214a (A) having the notch 224a may be in communication with fluid (e.g., high-pressure fluid) being expelled from the cylinder 274. The notches 224a, 224b can improve flow metering while lowering a load during lifting applications and can help the user control the flow back for a more significant range of motion during the rotor 200 rotation.

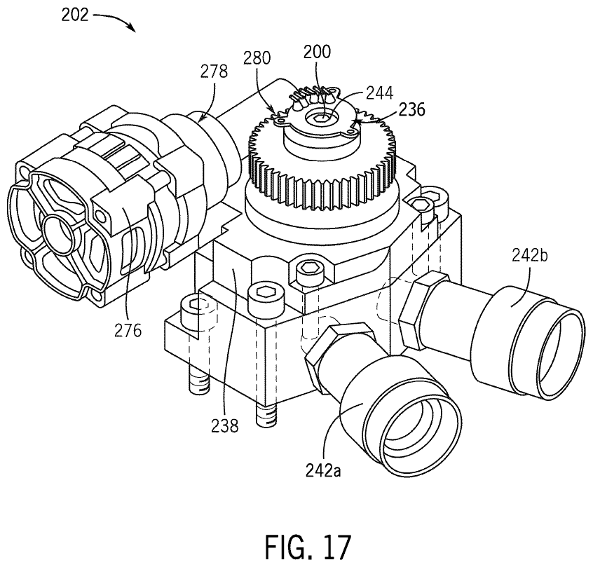

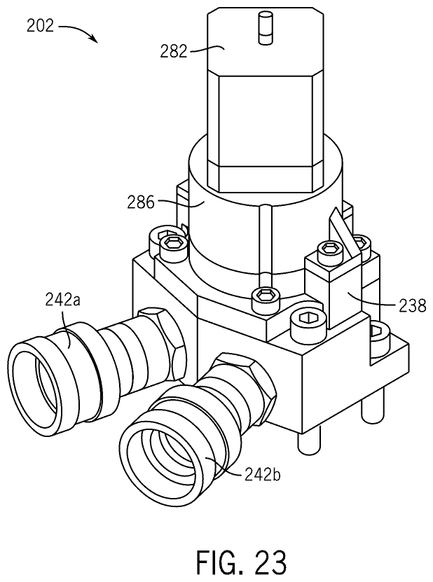

To move the valve between the three positions, the valve body is activated using motors coupled with gear trains, according to some embodiments. FIGS. 17-22 illustrate a first configuration, which includes a brushless motor 276 (e.g., a brushless electric DC motor, or BLDC) and two gear trains 278, 280 (e.g., a planetary gear set, and a worm gear set). FIGS. 23-25 illustrate a second configuration, which can include a stepper motor 282 and a gear train 284 (e.g., a planetary gear set). The position of the valve 202 is controlled by a controller 236 (see FIG. 17) with, for example, a ZMID sensor and the angular steps of the motor 282. In this second configuration, there can be two different combinations (e.g., setups). The first combination includes the stepper motor 282 (e.g., NEMA 23 or a higher torque stepper motor) and the gear train 284 as a single gear train. The second combination includes the stepper motor 282 (e.g., NEMA 17 or a lower torque stepper motor) and the gear train 284 as a two-stage gear train (e.g., a two-stage planetary gear set). Generally, in some embodiments, the first configuration can permit a greater gear reduction compared to the second configuration. Also, in some embodiments, the second configuration can reduce the gear ratio for actuating the valve 202, and increase the control and accuracy of the position of the valve 202. In either configuration, the position of the valve 202 can be maintained regardless of power being on (e.g., in comparison to solenoid-actuated valves, which require power to be on to maintain position of a valve).

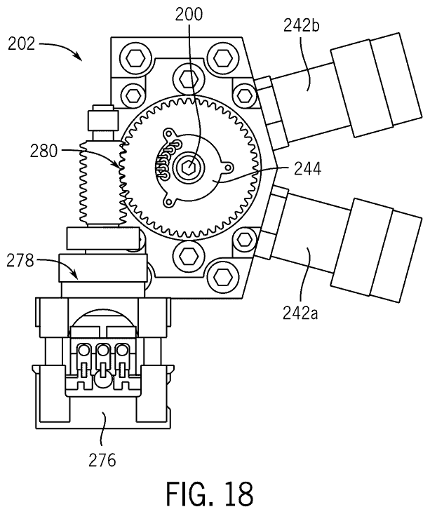

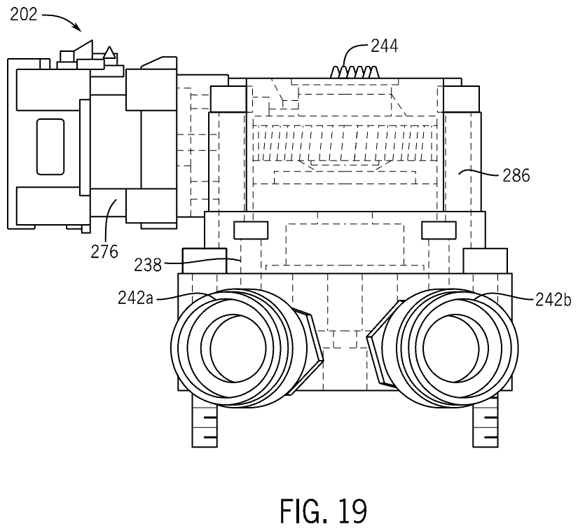

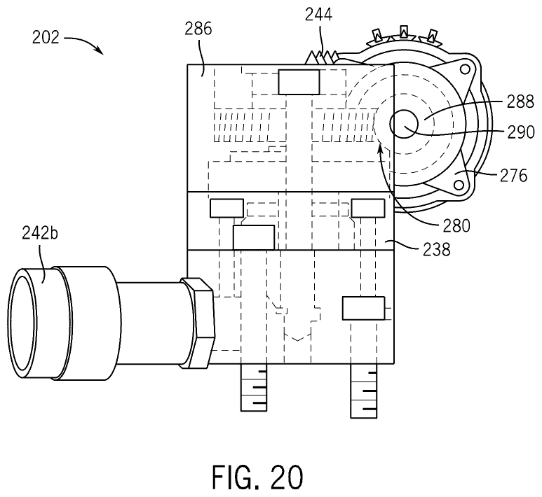

FIGS. 17 and 18 illustrate the first configuration with a gear housing 286 hidden to show the internal components. The first configuration uses the brushless motor 276 coupled to the first gear train 278 (e.g., planetary set). The first gear train 278 is coupled to the second gear train 280 (e.g., worm gear set) to rotate the valve 202 (e.g., act as a transmission). The position of the valve 202 is controlled by, for example, the sensor 244, such as a ZMID sensor or a Hall sensor. The position of the rotor 200 can also be controlled by the sensor 244. In some cases, the sensor arm 246 is coupled to the rotor 200 and a sensor board s located below the rotor 200. The first configuration includes the valve cap 238. The valve cap 238 houses the rotor 200 and connects to the pump. FIGS. 19-21 illustrate the first configuration with the gear housing 286. FIG. 20 illustrates the gear housing 286 including an aperture 288. The aperture 288 allows access to a shaft 290 (e.g. worm) of the second gear train 280 to manually actuate the valve 202 if needed.

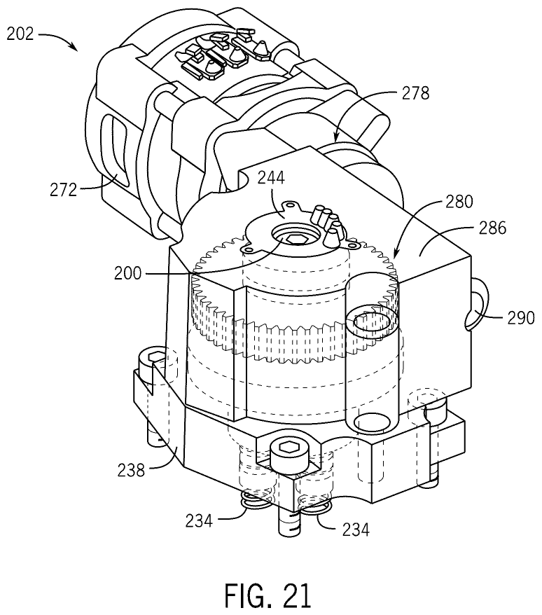

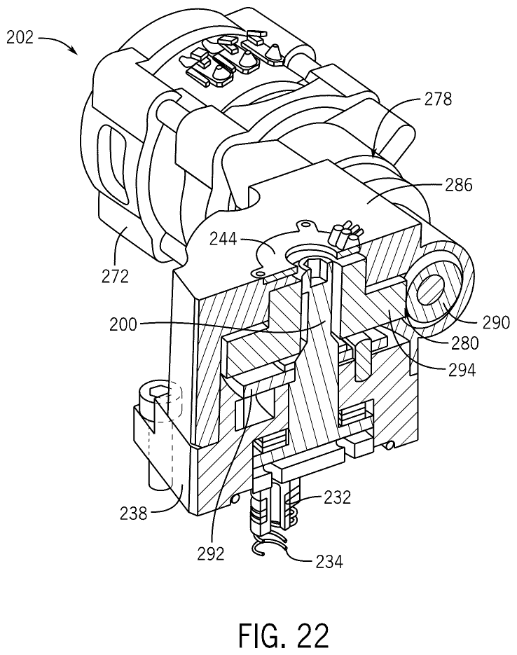

FIGS. 21 and 22 illustrate further views of the first configuration. In particular, FIG. 22 illustrates a cross-sectional view showing the shaft 290, the second gear train 280, the sensor 244, the rotor 200, a stopper 292, the discs 232, and the springs 234. The sensor 244 is connected to the gear housing 286. The second gear train 280 includes the shaft 290 and a worm wheel 294. The stopper 292 is a mechanical stop that restricts the rotation of the rotor 200 to a desired angle.

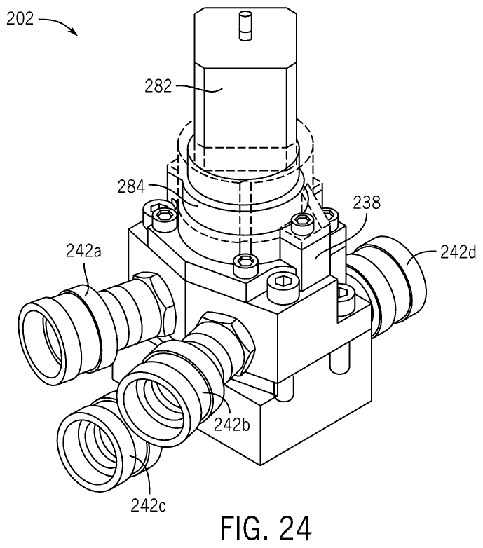

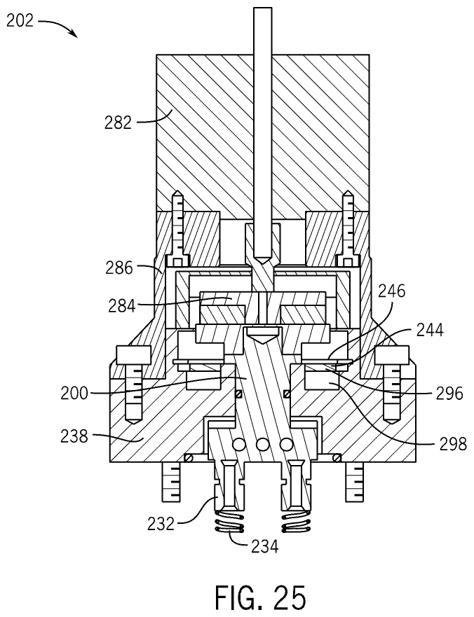

FIGS. 23-25 illustrates views of the second configuration. As noted above, the second configuration uses the stepper motor 282 coupled with the gear train 284 (see FIG. 24 and FIG. 25) for a transmission. The gear train 284 can be a one-stage planetary gear set or a two-stage planetary gear set. The gear train 284 is configured to provide increased angular rotation capabilities as compared to rotary valves used in a two-position, two-way configuration having one gear.

The gear housing 286 houses the gear train 284. The gear housing 286 is coupled between the valve cap 238 and the stepper motor 282. The second configuration also includes the sensor 244 to control the rotor 200. For example, a ZMID sensor can be used. The sensor 244 can included the sensor arm 246 that is coupled to the rotor 200. A sensor board 296 is located between the sensor arm 246 and a cavity 298 in the valve cap 238.

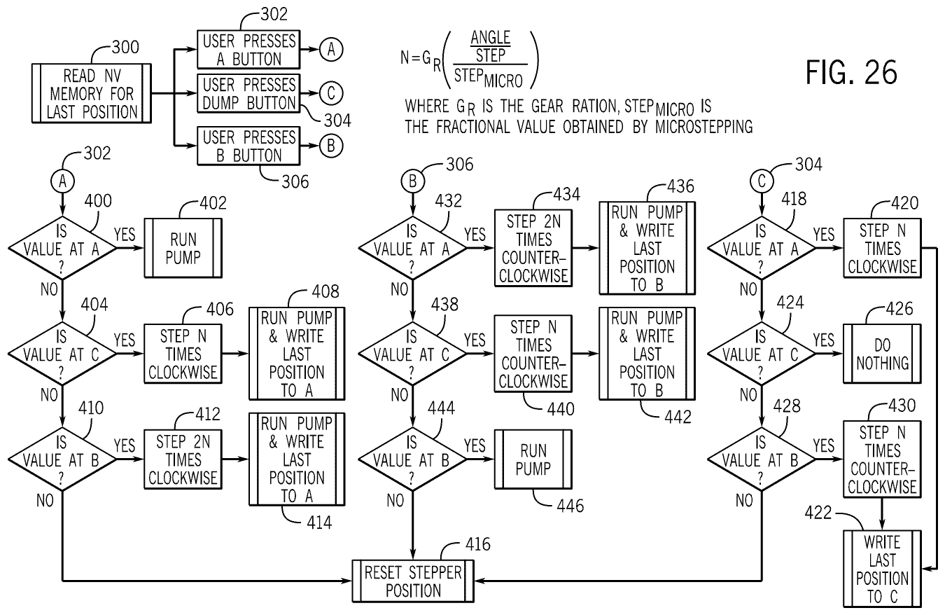

FIGS. 26-34 illustrate a method of operating the valve 202. It is appreciated that aspect of this and other methods can be performed using the controller 236, which can be in communication (e.g., to send or receive signals) with a motor, sensors, or other components of a valve. Referring to FIG. 26, at block 300, the memory determines the last position of the valve 202. a user input can be received to command valve operation. The last position obtained from the memory can correspond with the user command. For example, at block 302, the user can press button A (e.g., corresponding to a valve position to charge A and provide pressurized fluid to Port A). At block 304, the user can press button C (e.g., corresponding to a valve position to dump pressure or relieve pressure and move the valve to the third position). At block 306, the user can press button B (e.g., corresponding to a valve position to charge B and provide pressurized fluid to Port B). Button A corresponds to Port P aligned with Port A. Button C corresponds to the Port P aligned with Port T which relieves pressure. Button B corresponds to Port P aligned with Port B. In some embodiments, in operation, the user can continue holding down the button for the pump to work.

If a user selects button A at block 302, the sensor 244 determines if Port P is aligned with Port A at block 400. If Port P is aligned with Port A and there is pressurized fluid at Port A, the process continues to block 402 to run the pump. If Port P is not aligned with Port A, the process continues to block 404. At block 404, the sensor 244 determines if Port P is aligned with Port T. If Port P is aligned with Port T, the process continues to block 406 to operate the stepper motor 282 to step N times in a second rotational direction (e.g., the number of steps the stepper motor 282 moves to port A in the clockwise direction). The process continues to block 408 to run the pump and writes the last position as A (e.g., Port A) to the non-volatile memory. At block 404, if Port P is not aligned with Port T, the process continues to block 410. If Port P is aligned with Port B and there is pressurized fluid at Port B, the process continues to block 412 to operate the stepper motor 282 to step 2N times in the second rotational direction. The process continues to block 414 to run the pump and writes the last position as A to the non-volatile memory. At block 410, if Port P is not aligned with Port B, the process continues to block 416 to reset the position of the stepper motor 282.

Still referring to FIG. 26, if the user selected button C at block 304, the sensor 244 determines if Port P is aligned with Port A at block 418. If Port P is aligned with Port A and there is pressurized fluid at Port A, the process continues to block 420 to operate the stepper motor 282 to step N times the second rotational direction. The process continues to block 422 to write the last position as C (e.g., Port T) to the non-volatile memory. At block 418, if Port P is not aligned with Port A, the process continues to block 424. At block 424, the sensor 244 determines if Port P is aligned with Port T at block 424. If Port P is aligned with Port T, the process continues to block 426 and nothing happens. If Port P is not aligned with Port T, the process continues to block 428. If Port P is aligned with Port B and there is pressurized fluid at Port B, the process continues to block 430 to operate the stepper motor 282 to step N times in a first rotational direction (e.g., counterclockwise) and continues to block 422 to write the last position as C to the non-volatile memory. At block 428, if Port P is not aligned with Port B, the process continues to block 416 to reset the position of the stepper motor 282.

Still referring to FIG. 26, if the user selected button B at block 306, the sensor 244 determines if Port P is aligned with Port A at block 432. If Port P is aligned with Port A and there is pressurized fluid at Port A, the process continues to block 434 to operate the stepper motor 282 to step 2N times in the first rotational direction. The process continues to block 436 to run the pump and write the last position as B (e.g., Port B) to the non-volatile memory. If Port P is not aligned with Port A, the process continues to block 438. At block 438, the sensor 244 determines if Port P is aligned with Port T. If Port P is aligned with Port T, the process continues to block 440 to operate the stepper motor 282 to step N times in the first rotational direction and the process continues to block 442 to run the pump and write last position as B to the non-volatile memory. If Port P is not aligned with Port T, the process continues to block 444. At block 444, if Port P is aligned with Port B and there is pressurized fluid at Port B, the process continues to block 446 to run the pump. If Port P is not aligned with Port B, the process continues to block 416 to reset the position of the stepper motor 282.

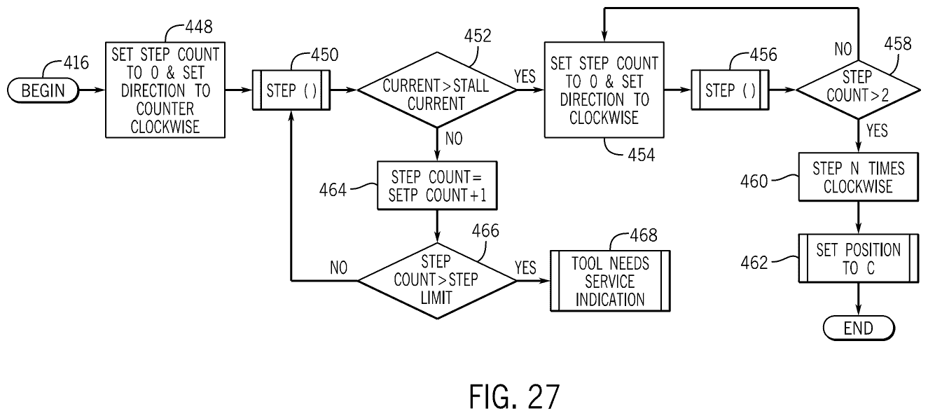

FIG. 27 illustrates a flow chart of block 416 in FIG. 26. For the position of the stepper motor 282 to reset, block 448 sets the step count to zero and sets the direction of the stepper motor 282 to the first rotational direction. At block 450, the sensor 244 determines the step count based on the rotational position of the motor 282 (e.g., the number of degrees). At block 452, the controller determines if the current is greater than the stall current. If the current is greater than the stall current, the process continues to block 454. At block 454, the step count is set to zero and the direction of the stepper motor 282 is set to the second rotational direction. At block 456, the sensor 244 determines the step count based on the rotational position of the motor 282. The controller determines if the step count is greater than two at block 458. If the step count is greater than two at block 258, the process continues to block 460 and block 462. At block 460, the controller operates the stepper motor 282 to step N times in the second direction. At block 462, the controller set the last position as C. Referring to block 458, if the step count is not greater than two, the process returns to block 454 and continues.

Referring to block 452, if the current is not greater than the stall current, the sensor 244 continues to block 464. At block 464, the step count is set to the current step count plus one. At block 466, the sensor 244 determines if the step count is greater than the step limit. If the step count is greater than the step limit, the sensor 244 continues to block 468 and indicates that the tool needs service. If the step count is not greater than the step limit, the sensor 244 returns to block 450 and continues.

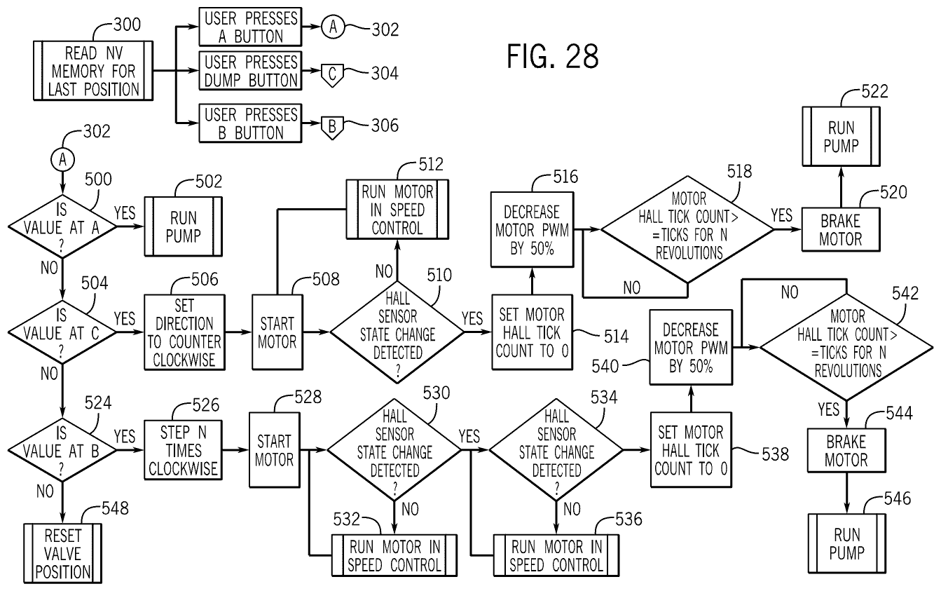

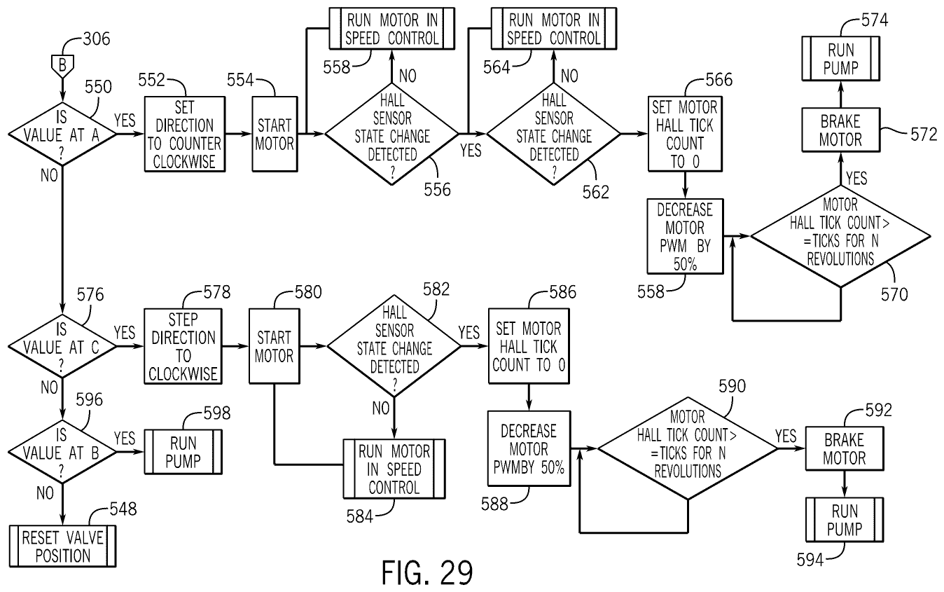

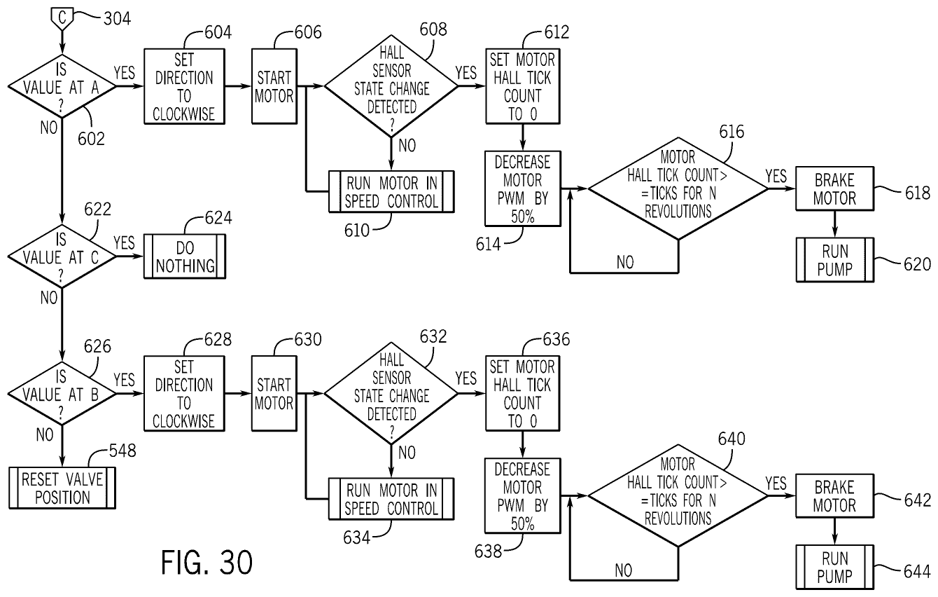

FIGS. 28-31 illustrate control of the brushless motor 276 with the sensor 244 (e.g., Motor Hall sensor). A user has the option to select block 302, 304, or 306 which are shown in detail in FIG. 28, FIG. 29, and FIG. 30. The sensor 244 monitors the location of the brushless motor 276 by tick counting. For example, the number of revolutions can be determined by counting ticks on the sensor 244. In some examples, the position of the sensor 244 can be offset by a present number of degrees, such as five degrees, to give time to slow down and start operation.

Now referring to FIG. 28, if the user selects (e.g., depresses) button A at block 302, the sensor 244 determines if Port P is aligned with Port A at block 500. If Port P is aligned with Port A, the process continues to block 502 to run the pump. At block 500, if Port P is not aligned with Port A, the process continues to block 504. At block 504, the sensor 244 determines if Port P is aligned with Port T. At block 504, if Port P is aligned with Port T, the process continues to block 506 to set the direction of the brushless motor 276 to the first rotational direction. At block 508, the brushless motor 276 starts. At block 510, the sensor 244 determines if the state changed was detected. If the state change was not detected, the controller at block 512 runs the brushless motor 276 in speed control and continues back to block 508. If the state change was detected, block 514 sets the tick count to zero and block 516 decreases motor pulse width modulation by 50 percent (e.g., a method of delivering energy through a series of pulses rather than a continuously varying (analog) signal). The controller regulates energy flow to the brushless motor 276 by increasing and decreasing the motor pulse width modulation. At block 518, the sensor 244 determines if the tick count is greater than or equal to ticks for N revolutions. If the tick count is not greater than or equal to ticks for N revolutions, the sensor 244 continues to monitor tick count. If the tick count is greater than or equal to ticks for N revolutions, the controller stops the brushless motor 276 at block 520 and runs the pump at block 522. Referring back to block 504, if Port P is not aligned with Port T, the process continues to block 524. At block 524, the sensor 244 determines if Port P is aligned with Port B. If Port P is aligned with Port B, the process continues to block 526 to set the direction of the brushless motor 276 to the second rotational direction and at block 528 the motor starts. At block 530, the sensor 244 determines if the state change is detected. If the state change is not detected, block 532 runs the brushless motor 276 in speed control and continues back to block 530. If the state change is detected, block 534 determines if the state change is detected again. If the state change is not detected, block 536 runs the brushless motor 276 in speed control and continues back to block 534. If the state change is detected, block 538 sets the tick count to zero and block 540 decreases motor pulse width modulation by 50 percent. At block 542, the sensor 244 determines if the tick count is greater than or equal to ticks for N revolutions. If the tick count is not greater than or equal to ticks for N revolutions, the sensor 244 continues to monitor tick count.

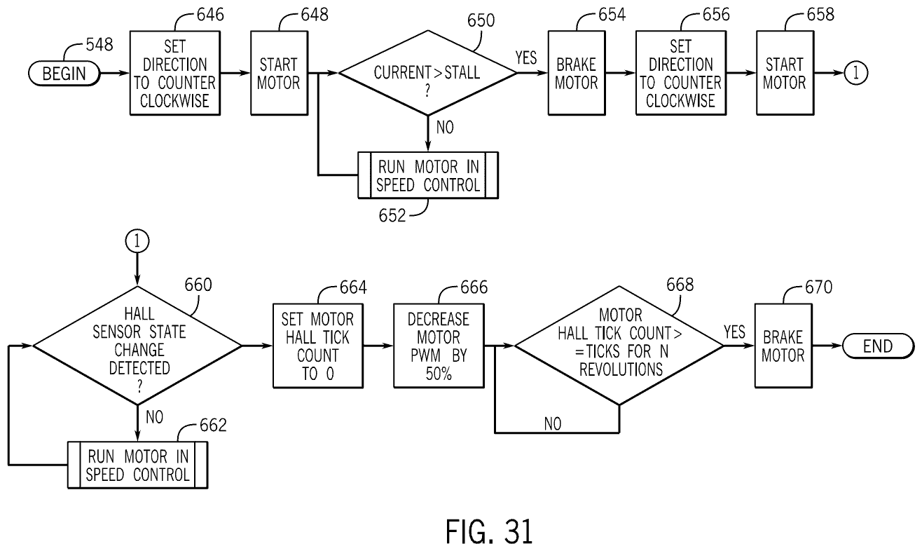

If the tick count is greater than or equal to ticks for N revolutions, the controller stops the brushless motor 276 at block 544 and runs the pump at block 546. Referring back to block 524, if Port P is not aligned with Port B, the position of the brushless motor 276 is reset at block 548 (see FIG. 31).

Now referring to FIG. 29, if the user selected button B at block 306, the sensor 244 determines if Port P is aligned with Port A at block 550. If Port P is aligned with Port A, the direction of the brushless motor 276 is set to the second rotational direction at block 552 and the motor starts at block 554. At block 556, the sensor 244 determines if the state change is detected. If the state change is not detected, block 558 runs the brushless motor 276 in speed control and continues back to block 556. If the state change is detected, block 560 determines if the state change is detected again. If the state change is not detected, block 562 runs the brushless motor 564 in speed control and continues back to block 562. If the state change is detected, block 566 sets the tick count to zero and block 568 decreases motor pulse width modulation by 50 percent. At block 570, the sensor 244 determines if the tick count is greater than or equal to ticks for N revolutions. If the tick count is not greater than or equal to ticks for N revolutions, the sensor 244 continues to monitor tick count. If the tick count is greater than or equal to ticks for N revolutions, the controller stops the brushless motor 276 at block 572 and runs the pump at block 574. Referring back to block 550, if Port P is not aligned with Port A, the process continues to block 576. At block 576, the sensor 244 determines if Port P is aligned with Port T. If Port P is aligned with Port T, the process continues to block 578 to set the direction of the brushless motor 276 to the second rotational direction. At block 580, the brushless motor 276 starts. At block 582, the sensor 244 determines if the state change is detected. If the state change is not detected, block 584 runs the brushless motor 276 in speed control and continues back to block 580. If the state change is detected, block 586 sets the tick count to zero and block 588 decreases motor pulse width modulation by 50 percent. At block 590, the sensor 244 determines if the tick count is greater than or equal to ticks for N revolutions. If the tick count is not greater than or equal to ticks for N revolutions, the sensor 244 continues to monitor tick count. If the tick count is greater than or equal to ticks for N revolutions, the controller stops the brushless motor 276 at block 592 and runs the pump at block 594. Referring back to block 576, if Port P is not aligned with Port T, the process continues to block 596. At block 596, the sensor 244 determines if Port P is aligned with Port B. If Port P is aligned with Port B, the process continues to block 598 to run the pump. At block 596, if Port P is not aligned with Port B, the position of the brushless motor 276 is reset at block 548 (see FIG. 31).

Now referring to FIG. 30, if the user selected button C at block 304, the sensor 244 determines if Port P is aligned with Port A at block 602. If Port P is aligned with Port A, the direction of the brushless motor 276 is set to the second rotational direction at block 604 and the motor starts at block 606. At block 608, the sensor 244 determines if the state change is detected. If the state change is not detected, block 610 runs the brushless motor 276 in speed control and continues back to block 608. If the state change is detected, block 612 sets the tick count to zero and block 614 decreases motor pulse width modulation by 50 percent. At block 616, the sensor 244 determines if the tick count is greater than or equal to ticks for N revolutions. If the tick count is not greater than or equal to ticks for N revolutions, the sensor 244 continues to monitor tick count. If the tick count is greater than or equal to ticks for N revolutions, the controller stops the brushless motor 276 at block 618 and runs the pump at block 620. Referring back to block 602, if Port P is not aligned with Port A, the process continues to block 622. At block 622, the sensor 244 determines if Port P is aligned with Port T. If Port P is aligned with Port T, the sensor 244 continues to block 624 to do nothing. If Port P is not aligned with Port T, the sensor 244 continues to block 626. At block 626, the sensor 244 determines if Port P is aligned with Port B. If Port P is aligned with Port B, the process continues to block 628 to set the direction of the brushless motor 276 to the second rotational direction. At block 630, the brushless motor 276 starts. At block 632, the sensor 244 determines if the state changed is detected. If the state change is not detected, block 634 runs the brushless motor 276 in speed control and continues back to block 632. If the state change is detected, block 636 sets the tick count to zero and block 638 decreases motor pulse width modulation by 50 percent. At block 640, the sensor 244 determines if the tick count is greater than or equal to ticks for N revolutions. If the tick count is not greater than or equal to ticks for N revolutions, the sensor 244 continues to monitor tick count. If the tick count is greater than or equal to ticks for N revolutions, the controller stops the brushless motor 276 at block 642 and runs the pump at block 644. Referring back to block 626, if Port P is not aligned with Port B, the position of the brushless motor 276 is reset at block 548 (see FIG. 31).

FIG. 31 illustrates a detailed flowchart of block 548. At block 646, the controller sets the direction of the brushless motor 276 to the first rotational direction. At block 648, the controller starts the brushless motor 276. At block 650, the sensor 244 determines if the current is greater than the stall current. If the current is not greater than the stall current, the brushless motor 276 runs in speed control at block 652. If the current is greater than the stall current, the brushless motor 276 stops at block 654. At block 656, the controller sets the direction of the brushless motor 276 to the first rotational direction. At block 658, the controller starts the brushless motor 276. At block 660, the sensor 244 determines if the state has changed. If the state has not changed, the brushless motor 276 runs in speed control at block 662. If the state has changed, the tick count is set to zero at block 664 and block 666 decreases motor pulse width modulation by 50 percent. At block 668, the sensor 244 determines if the tick count is greater than or equal to ticks for N revolutions. If the tick count is greater than or equal to ticks for N revolutions, the controller stops the brushless motor 276 at block 670. If the tick count is not greater than or equal to ticks for N revolutions, the sensor 244 continues to monitor tick count.

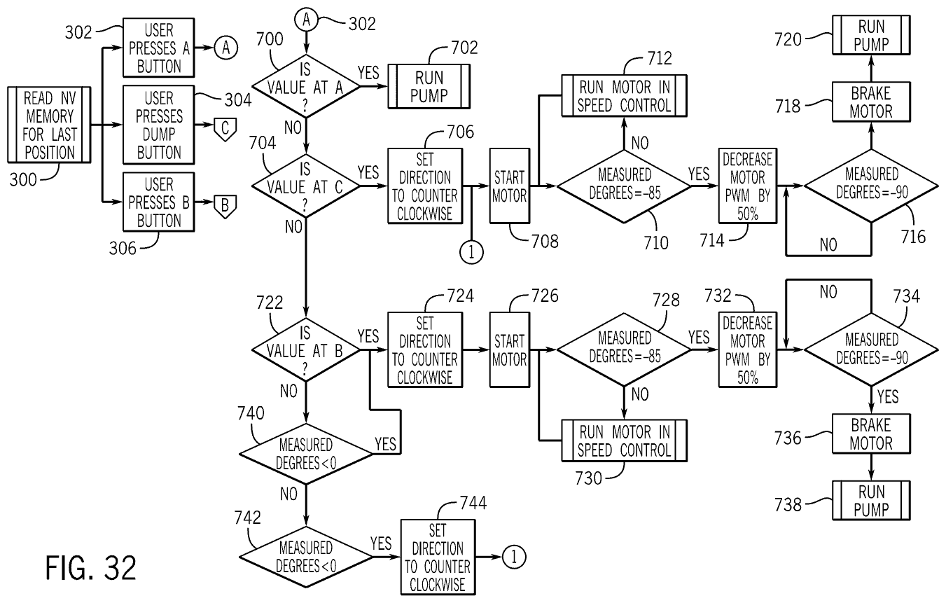

FIGS. 32-34 illustrate control of the brushless motor 276 with the sensor 244 (e.g., ZMID position sensor or inductor sensing). The sensor 244 determines the number of degrees the brushless motor 276 has rotated to align Port P with the desired port.

FIG. 32 illustrates a detailed flowchart of block 302 with the brushless motor 276 and sensor 244. If the user selected button A at block 302, the sensor 244 determines if Port P is aligned with Port A at block 700. If Port P is aligned with Port A, the process continues to block 702 to run the pump. At block 700, if Port P is not aligned with Port A, the process continues to block 704. At block 704, the sensor 244 determines if Port P is aligned with Port T. At block 704, if Port P is aligned with Port T, the process continues to block 706 to set the direction of the brushless motor 276 to the first rotational direction. At block 708, the brushless motor 276 starts. At block 710, the sensor 244 determines if the brushless motor 276 is measured at −85 degrees (e.g., offset below 85 degrees). If the brushless motor 276 is not measured at −85 degrees, the brushless motor 276 runs in speed control at block 712 and continues back to block 710. If the brushless motor 276 is measured at −85 degrees, the motor pulse width modulation decreases by 50 percent at block 714. At block 716, the sensor 244 determines if the brushless motor 276 is measured at −90 degrees (e.g., offset below 90 degrees). If the brushless motor 276 is not measured at −90 degrees, the sensor 244 continues to monitor if the brushless motor 276 is measured at −90 degrees. If the brushless motor 276 is measured at −90 degrees, at block 718 the brushless motor 276 stops and at block 720 the pump runs. Referring back to block 704, if Port P is not aligned to Port T, the process continues to block 722. At block 722, the sensor 244 determines if Port P is aligned with Port B. If Port P is aligned with Port B, the process continues to block 724 and sets the direction of the brushless motor 276 to the first rotational direction. At block 726, the brushless motor 276 starts. At block 728, the sensor 244 determines if the brushless motor 276 is measured at −85 degrees (e.g., offset below 85 degrees). If the brushless motor 276 is not measured at −85 degrees, at block 730 the brushless motor 276 runs in speed control and continues back to block 728. If the brushless motor 276 is measured at −85 degrees, the motor pulse width modulation decreases by 50 percent at block 732. At block 734, the sensor 244 determines if the brushless motor 276 is measured at −90 degrees (e.g., offset below 90 degrees). If the brushless motor 276 is not measured at −90 degrees, the sensor 244 continues to monitor if the brushless motor 276 is measured at −90 degrees. If the brushless motor 276 is measured at −90 degrees, the brushless motor 276 stops at block 736 and the pump runs at block 738. Referring back to block 722, if Port P is not aligned to Port B, the process continues to block 740 to determine if the measured degrees is less than zero. If the measured degree is less than zero, the process continues to block 724. If the measured degree is not less than zero, the sensor 244 continues to block 742 to determine again if the measured degree is less than zero. If the measured degree is less than zero, the process continues to block 744 to set the direction of the brushless motor 276 to the first rotational direction.

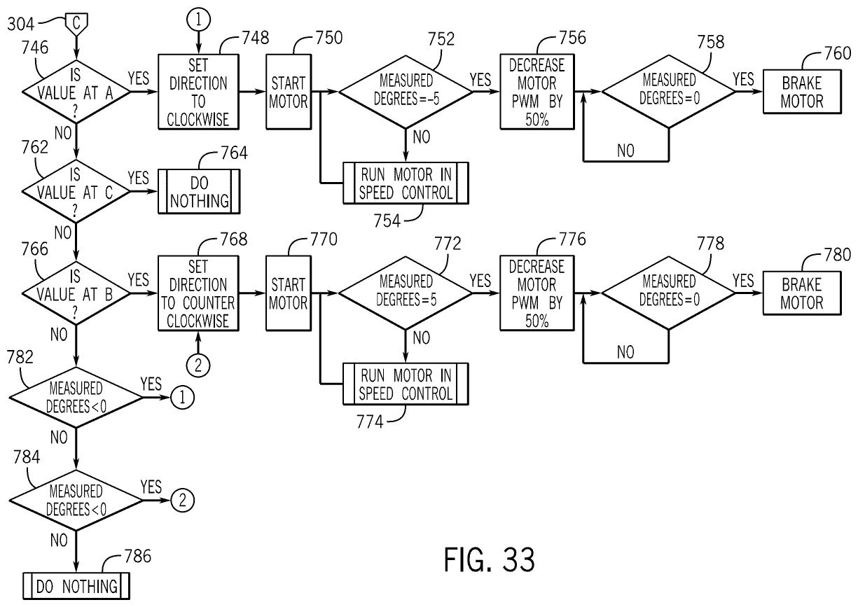

FIG. 33 illustrates a detailed flowchart of block 304 with the brushless motor 276 and the sensor 244. If the user selected button C at block 304, the sensor 244 determines if Port P is aligned with Port A at block 746. If Port P is aligned with Port A, the process continues to block 748 to set the direction of the brushless motor 276 to the second rotational direction. At block 750, the motor brushless 276 starts. At block 752, the sensor 244 determines if the brushless motor 276 is measured at −5 degrees (e.g., offset below 5 degrees). If the brushless motor 276 is not measured at −5 degrees, the brushless motor 276 runs in speed control at block 754 and continues back to block 752. If the brushless motor 276 is measured at −5 degrees, the process continues to block 765 to decrease the motor pulse width modulation by 50 percent. At block 758, the sensor 244 determines if the brushless motor 276 is measured at 0 degrees (e.g., offset by 0 degrees). If the brushless motor 276 is not measured at 0 degrees, the sensor 244 continues to monitor if the brushless motor 276 is measured at 0 degrees. If the brushless motor 276 is measured at 0 degrees, at block 760 the brushless motor 276 stops. Referring back to block 746, if Port P is not aligned with Port A, the process continues to block 762. At block 762, the sensor 244 determines if Port P is aligned with Port T. If Port P is aligned with Port T, the process continues to block 764 and nothing happens. If Port P is not aligned with Port T, the process continues to block 766. At block 766, the sensor 244 determines if Port P is aligned with Port B. If Port P is aligned with Port B, the process continues to block 768 to set the direction of the brushless motor 276 to the first rotational direction. At block 770, the brushless motor 276 starts. At block 772, the sensor 244 determines if the brushless motor 276 is measured at 5 degrees (e.g., offset above 5 degrees). If the brushless motor 276 is not measured at 5 degrees, the brushless motor 276 runs in speed control at block 774 and the process continues to back to block 772. If the brushless motor 276 is measured at 5 degrees, the process continues to block 776 to decrease the motor pulse width modulation by 50 percent. At block 778, the sensor 244 determines if the brushless motor 276 is measured at 0 degrees. If the brushless motor 276 is not measured at 0 degrees, the sensor 244 continues to monitor if the brushless motor 276 is measured at 0 degrees. If the brushless motor 276 is measured at 0 degrees, at block 780 the brushless motor 276 stops. Referring back to block 766, if Port P is not aligned with Port T, the process continues to block 782. At block 782, the sensor 244 determines if the measured degree of the brushless motor 276 is less than zero. If the measured degree is less than zero, the process continues back to block 748. If the measured degree is not less than zero, the sensor 244 continues to block 784 to determine again if the measured degree of the brushless motor 276 is less than zero. If the measured degree is less than zero, the process continues back to block 768. If the measured degree is not less than zero, the process continues to block 786 to do nothing.

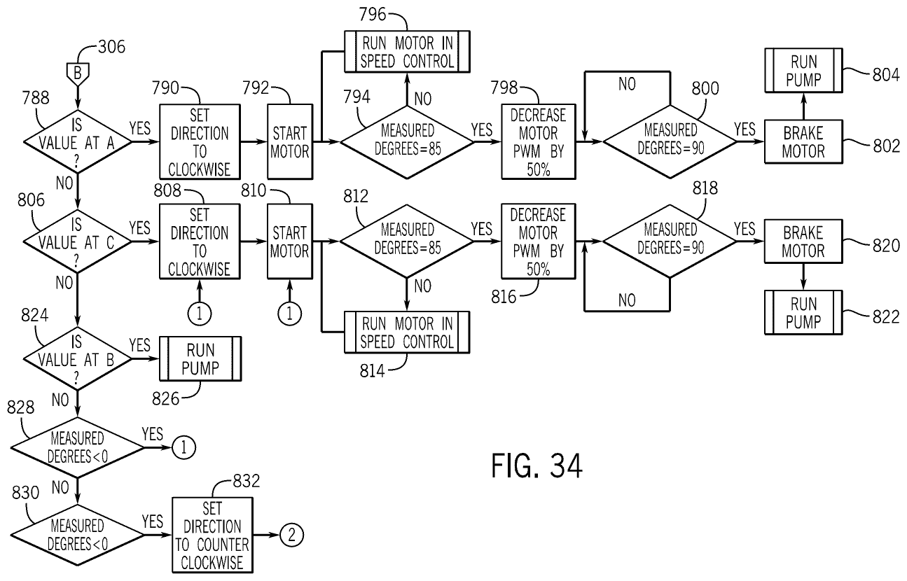

FIG. 34 illustrates a detailed flowchart of block 306 with the brushless motor 276 and the sensor 244. If the user selected button B at block 306, the sensor 244 determines if Port P is aligned with Port A at block 788. If Port P is aligned with Port A, the process continues to block 790 to set the direction of the brushless motor 276 to the second rotational direction. At block 792, the brushless motor 276 starts. At block 794, the sensor 244 determines if the brushless motor 276 is measured at 85 degrees (e.g., offset above 85 degrees). If the brushless motor 276 is not measured at 85 degrees, the brushless motor 276 runs in speed control at block 796 and continues back to block 794. If the brushless motor 276 is measured at 85 degrees, the motor pulse width modulation decreases by 50 percent at block 798. At block 800, the sensor 244 determines if the brushless motor 276 is measured at 90 degrees (e.g., offset above 90 degrees). If the brushless motor 276 is not measured at 90 degrees, the sensor 244 continues to monitor if the brushless motor 276 is measured at 90 degrees. If the brushless motor 276 is measured at 90 degrees, the brushless motor 276 stops at block 802 and the pump runs at block 804. Referring back to block 788, if Port P is not aligned to Port A, the process continues to block 806. At block 806, the sensor 244 determines if Port P is aligned with Port T. If Port P is aligned with Port T, the process continues to block 808 to set the direction of the brushless motor 276 to the second rotational direction. At block 810, the brushless motor 276 starts. At block 812, the sensor 244 determines if the brushless motor 276 is measured at 85 degrees (e.g., offset above 85 degrees). If the brushless motor 276 is not measured at 85 degrees, the brushless motor 276 runs in speed control at block 814 and continues back to block 812. If the brushless motor 276 is measured at 85 degrees, the motor pulse width modulation decreases by 50 percent at block 816. At block 818, the sensor 244 determines if the brushless motor 276 is measured at 90 degrees (e.g., offset above 90 degrees). If the brushless motor 276 is not measured at 90 degrees, the sensor 244 continues to monitor if the brushless motor 276 is measured at 90 degrees. If the brushless motor 276 is measured at 90 degrees, the brushless motor 276 stops at block 820 and the pump runs at block 822. Referring back to block 806, if Port P is not aligned to Port T, the process continues to block 824. At block 824, the sensor 244 determines if Port P is aligned with Port B. If Port P is aligned with Port B, the process continues to block 826 and the pump runs. If Port P is not aligned to Port B, the sensor 244 continues to block 828 to determine if the measured degrees is less than zero. If the measured degree is less than zero, the process continues to blocks 808 and 810. If the measured degree is not less than zero, the process continues to block 830 to determine again if the measured degrees is less than zero. If the measured degree is less than zero, the process continues to block 832 to set the direction of the brushless motor 276 to the first rotational direction.

Additionally, though not specifically shown and described herein, some embodiments may include a stepper motor and a ZMID sensor.

Thus, embodiments of the disclosed invention can provide a system and method for advancing and retracting a piston of a hydraulic tool via a rotary shear seal valve. The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

The above detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

It is to be understood that the invention is not limited in its application to the details of construction and the arrangement of components set forth in the following description or illustrated in the attached drawings. The invention is capable of other embodiments and of being practiced or of being carried out in various ways. Also, it is to be understood that the phraseology and terminology used herein is for the purpose of description and should not be regarded as limiting. For example, the use of “including,” “comprising,” or “having” and variations thereof herein is meant to encompass the items listed thereafter and equivalents thereof as well as additional items.

What is claimed is:

1. A rotor for a directional control valve, the rotor comprising:
a rotor body defining a sealing surface, a circumferential side surface, and a stem that receives a rotational input to rotate the rotor about an axis;
a first opening formed in the sealing surface and defining a first perimeter, the first opening positioned to move along a rotation path as the rotor body rotates and the first opening having a first notch extending from the first perimeter toward a centerline of the rotor body that is perpendicular to the axis and along the rotation path; and
a second opening formed in the sealing surface and defining a second perimeter, the second opening positioned to move along the rotation path as the rotor body rotates and the second opening having a second notch extending from the second perimeter toward the centerline of the rotor body and along the rotation path.

2. The rotor of claim 1, wherein each of the first perimeter and the second perimeter has a circular shape and each of the first notch and the second notch is formed as a triangular portion.

3. The rotor of claim 2, wherein the triangular portion defines an arcuate base and a peak opposite the arcuate base, and
wherein the rotation path bisects the arcuate base and intersects the peak.

4. The rotor of claim 1, further comprising:
a third opening formed in the sealing surface and defining a third perimeter, the third perimeter defining a circular shape and having an open area that is less than an open area of the first opening; and
a fourth opening formed in the sealing surface and defining a fourth perimeter, the fourth perimeter defining a circular geometry and a surface area less than the first perimeter of the first opening.

5. The rotor of claim 4, wherein the first and the second openings are in fluid communication with each other and the third and the fourth openings are in fluid communication with each other.

6. The rotor of claim 1, wherein the first notch and the second notch are shaped to facilitate a linear decrease in pressure when the rotor is rotated.

7. The rotor of claim 1, wherein the directional control valve is rotatable between three positions:
a first position that fluidly couples the first opening with a pressure source and the second opening with a tank;
a second position that fluidly couples the first opening with the tank and the second opening with the pressure source; and
a third position where the first opening and the second opening are not fluidly coupled to the tank or the pressure source.

8. The rotor of claim 7, wherein the first position corresponds to an extension of a piston rod within a cylinder of a piston cylinder assembly, and the second position corresponds to a retraction of the piston rod within the cylinder of the piston cylinder assembly.

9. A shear seal control valve, comprising:
a valve body defining first and second ports; and
a rotor rotatably received in the valve body and having a plurality of openings formed in a mating surface of the rotor, the plurality of openings arranged to allow selective coupling of the first and second ports as the rotor rotates in the valve body,
the plurality of openings including first and second openings that each define a perimeter having a partially circular portion and a triangular portion, the respective triangular portions defining a notch of the respective first and second openings.

10. The shear seal control valve of claim 9, wherein the plurality of openings further includes a third opening and a fourth opening that define a surface area less than the perimeter of the first opening and the second opening.

11. The shear seal control valve of claim 10, wherein the first and second openings are in fluid communication with each other and the third and fourth openings are in fluid communication with each other.

12. The shear seal control valve of claim 9, wherein the notches provide a linear pressure decrease in hydraulic pressure as the rotor is rotated from a first position to a second position.

13. The shear seal control valve of claim 12, wherein the first opening is coupled with a pressure source and the second opening is coupled with a tank in the first position.

14. The shear seal control valve of claim 13, wherein the first opening is coupled with the tank and the second opening is coupled with the pressure source in the second position.

15. A method of operating a piston via a rotary shear seal valve, the method comprising:
rotating a rotor to a first position;
fluidly coupling a pressure source with a first opening and fluidly coupling a second opening with a tank;
extending a piston within a cylinder of a piston cylinder assembly that causes an operation on a workpiece;
rotating a rotor to a second position;
fluidly coupling a first notch of the first opening with the tank and fluidly coupling a second notch of the second opening with the pressure source; and
retracting the piston within the cylinder of the piston cylinder assembly.

16. The method of claim 15, wherein the rotor rotates in a first rotational direction to reach the first position and in a second rotational direction to reach the second position, the first rotational direction being opposite the first rotational direction.

17. The method of claim 15, further comprising:
rotating a rotor to a third position; and
fluidly decoupling the first opening, the second opening, the pressure source, and the tank.

18. The method of claim 17, wherein the third position is a neutral position between the first position and the second position that blocks fluid flow through the first opening and the second opening.

19. The method of claim 15, wherein the first notch and the second notch are located on a rotation path of the rotor that increases flow metering.

20. The method of claim 19, wherein the first notch and the second notch are triangular-shaped.
